(19) United States
(12) Patent Application Publication
(10) Pub. No.: US 2026/0166947 A1
(43) Pub. Date: Jun. 18, 2026

(54) ROOF-MOUNTED AIR CONDITIONER AND VEHICLE

(71) Applicant: GD MIDEA AIR-CONDITIONING EQUIPMENT CO., LTD., Foshan (CN)

(72) Inventors: Yinyin ZHANG, Foshan (CN); Zhicai CAI, Foshan (CN); Haibiao CHEN, Foshan (CN); Hanbin WANG, Foshan (CN); Jiaquan QIN, Foshan (CN); Qing TAO, Foshan (CN)

(21) Appl. No.: 19/124,625

(22) PCT Filed: Nov. 30, 2022
(86) PCT No.: PCT/CN2022/135537

§ 371 Date: Apr. 25, 2025

(30) Foreign Application Priority Data
Nov. 18, 2022 (CN) 202211445519.1
Nov. 18, 2022 (CN) 202223073576.X

(51) Int. Cl. B60H 1/00; B60H 1/32

(52) U.S. Cl. CPC B60H 1/00564; B60H 1/00578; B60H 1/3229; B60H 2001/00235

(57) ABSTRACT

A roof-mounted air conditioner includes a chassis having indoor air inlet and outlet, a compressor on the chassis, an inner air duct assembly including an inner fan arranged between the indoor air inlet and outlet, an inner air duct component forming an indoor air duct communicating the indoor air inlet and outlet, and an inner air duct fixation cover fixedly connected to the chassis, an outer air duct assembly including an outer air duct fixation member fixedly connected to the chassis and an outer fan fixedly connected to the outer air duct fixation member, an electronic control box assembly arranged between the inner and outer air duct fixation members, and a wire fixation mechanism provided on at least one of the inner air duct fixation cover or the outer air duct fixation member and configured to fix a wire having one end connected to the electronic control box assembly.

### CROSS-REFERENCE TO RELATED APPLICATIONS

This application claims priority to Chinese Patent Application No. 202211445519.1, filed Nov. 18, 2022 and entitled “Roof-mounted air conditioner and vehicle” and Chinese Patent Application No. 202223073576.X, filed Nov. 18, 2022 and entitled “Roof-mounted air conditioner and vehicle,” the entire contents of both of which are incorporated herein by reference.

### FIELD

The present disclosure relates to the technical field of air conditioning equipment, and in particular to a roof-mounted air conditioner and a vehicle.

### BACKGROUND

In the related art, a roof-mounted air conditioner is generally mounted on the roof of a recreational vehicle. As the vehicle bumps along, the roof-mounted air conditioner will shake, making its internal electrical reliability face a harsh vibration environment. If the wiring of the roof-mounted air conditioner lacks effective fixation, the electrical safety will not be fully guaranteed.

### SUMMARY

The present disclosure aims to resolve at least one of the problems in the related art. To this end, the present disclosure provides a roof-mounted air conditioner, in which the wires connected to the electronic control box assembly are effectively fixed, thereby improving the reliability of the wires and ensuring the electrical safety performance of the roof-mounted air conditioner.

The present disclosure further provides a vehicle including the roof-mounted air conditioner.

In accordance with a first aspect of the present disclosure, an embodiment provides a roof-mounted air conditioner, including a chassis, a compressor, an inner air duct assembly, an outer air duct assembly, an electronic control box assembly, and a wire fixation mechanism. The chassis is provided with an indoor air inlet and an indoor air outlet. The compressor is arranged on the chassis. The inner air duct assembly includes an inner fan, an inner air duct component, and an inner air duct fixation cover. The inner air duct component forms an indoor air duct communicating the indoor air inlet and the indoor air outlet. The inner fan is arranged between the indoor air inlet and the indoor air outlet. The inner air duct fixation cover is fixedly connected to the chassis to secure the inner air duct component. The outer air duct assembly includes an outer air duct fixation member and an outer fan. The outer air duct fixation member is fixedly connected to the chassis. The outer fan is fixedly connected to the outer air duct fixation member. The electronic control box assembly is erected between the inner air duct fixation cover and the outer air duct fixation member. The wire fixation mechanism is provided on at least one of the inner air duct fixation cover and the outer air duct fixation member and is configured to fix a wire having one end connected to the electronic control box assembly.

In accordance with a second aspect of the present disclosure, an embodiment provides a vehicle including the roof-mounted air conditioner in accordance with the embodiments of the first aspect.

The roof-mounted air conditioner of the embodiments of the present disclosure at least has the following advantages.

In the inner air duct assembly, the inner air duct component forms the indoor air duct in communication with the indoor air inlet and the indoor air outlet, such that the indoor air duct is separated from the outer air duct assembly. The compressor is arranged on the chassis. The inner air duct fixation cover is arranged outside the air duct component. The inner air duct fixation cover and the outer air duct fixation member are respectively fixedly connected to the chassis. The inner air duct component is fixed to the chassis through the inner air duct fixation cover. The electronic control box assembly is erected between the inner air duct fixation cover and the outer air duct fixation member, such that the electronic control box assembly is supported and fixed. The wire fixation mechanism is arranged on either or each of the inner air duct fixation cover and the outer air duct fixation member. The wire connected to the electronic control box assembly is fixed through the wire fixation mechanism, such that the wire is effectively fixed, making the wiring layout structure more stable and reliable and the wire fixing mode more reasonable, facilitating the organized arrangement of the wire connected to the electronic control box assembly, ensuring the electrical safety performance of the roof-mounted air conditioner, and allowing the roof-mounted air conditioner to be used in a vehicle such as a recreational vehicle.

Additional features and advantages of the disclosure will be set forth in the description which follows, and in part will be obvious from the description, or may be learned by the practice of the disclosure.

### BRIEF DESCRIPTION OF DRAWINGS

FIG. 1 is a schematic structural view of a roof-mounted air conditioner according to an embodiment of the present disclosure;

FIG. 2 is a schematic structural view of a roof-mounted air conditioner without a top cover according to an embodiment of the present disclosure;

FIG. 3 is a schematic structural view of a roof-mounted air conditioner without a top cover according to an embodiment of the present disclosure when viewed from another angle;

FIG. 4 is a schematic structural view of a roof-mounted air conditioner according to an embodiment of the present disclosure when viewed from the right side;

FIG. 5 is a schematic structural view of a roof-mounted air conditioner according to an embodiment of the present disclosure when viewed from the left side;

FIG. 6 is a schematic structural view of wiring of mounted components according to an embodiment of the present disclosure;

FIG. 7 is a schematic structural view of an inner air duct fixation cover according to an embodiment of the present disclosure;

FIG. 8 is a schematic structural side view of an inner air duct fixation cover according to an embodiment of the present disclosure;

FIG. 9 is a schematic structural top view of a roof-mounted air conditioner according to an embodiment of the present disclosure;

FIG. 10 is a schematic sectional view taken along line A-A in FIG. 9; and

FIG. 11 is a schematic sectional view taken along line B-B in FIG. 9.

### LIST OF REFERENCE NUMERALS AS FOLLOWINGS

chassis 100; indoor air inlet 110; indoor air outlet 120; support base 130; wire outlet slot 131; fifth wire fixation hook 140; sixth wire fixation hook 150; first wire fixation member 160;
top cover 200; air intake grill 210;
inner air duct assembly 300; indoor heat exchanger 301; evaporator 310; inner air duct component 320; upper component 321; lower component 322; inner air duct fixation cover 330; first wire fixation hook 331; second wire fixation hook 332; first wire passing groove 333; third wire fixation hook 334; second wire passing groove 335; fourth wire fixation hook 336; housing 337; wire pressing column 338; inner fan 340; inner motor 341; impeller 342; inner motor wire 343;
outer air duct assembly 400; outdoor heat exchanger 401; condenser 410; outlet pipe temperature sensing wire 411; outer air duct fixation member 420; seventh wire fixation hook 421; eighth wire fixation hook 422; ninth wire fixation hook 423; outer fan 430; outer motor 431; impeller 432; outer motor wire 433; mounting frame 440;
electronic control box assembly 500; outdoor environment temperature sensing wire 510; second wire fixation member 520; tenth wire fixation hook 530; third wire 540; power cable 541; signal cable 542; fourth wire 550; indoor environment temperature sensing wire 551;
compressor 600; compressor wire 610; exhaust pipe temperature sensing wire 620;
reactor 700; reactor wire 710;
air exhaust grill 800;
wire fixation mechanism 900;
roof-mounted air conditioner 1000.

### DETAILED DESCRIPTION OF EMBODIMENTS

Embodiments of the present disclosure will be described in detail hereinafter in conjunction with accompanying drawings in which the same or like reference numerals refer to the same or like elements or elements having the same or like functions throughout. The embodiments described below by reference to the accompanying drawings are exemplary and are intended for illustration only and are not to be construed as limiting the present disclosure.

In the description of the present disclosure, it should be understood that orientation or position relationships indicated by the terms such as front, rear, up, down, left and right are based on orientation or position relationships shown in the accompanying drawings, and are used only for ease and brevity of illustration and description, rather than indicating or implying that the mentioned apparatus or component need to have a particular orientation or need to be constructed and operated in a particular orientation. Therefore, such terms should not be construed as limiting of the present disclosure.

In the description of the present disclosure, the terms such as first, second and the like used herein are merely used for distinguishing technical features, and are not intended to indicate or imply relative importance, or implicitly point out the number of the indicated technical features, or implicitly point out the order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

A roof-mounted air conditioner is generally mounted on the roof of the recreational vehicle. As the vehicle bumps along, the roof-mounted air conditioner will shake, making its internal electrical reliability face a harsh vibration environment. The wiring of the roof-mounted air conditioner lacks effective fixation, and the electrical safety of the product may not be fully guaranteed. It is found that in the related art, a wire connected to an electronic control box in the roof-mounted air conditioner is generally fixed by an external auxiliary member, leading to additional costs and low operation efficiency. According to a roof-mounted air conditioner of the embodiments of the present disclosure, a wire connected to the electronic control box assembly is fixed through a wire fixation mechanism, such that the wire is effectively fixed, making the wiring layout structure more stable and reliable, facilitating the organized arrangement of the wire connected to the electronic control box assembly, ensuring the electrical safety performance of the roof-mounted air conditioner, and allowing the roof-mounted air conditioner to be used in a vehicle such as a recreational vehicle.

The technical schemes adopted in the present disclosure will be described clearly and fully in conjunction with the accompanying drawings. Apparently, the embodiments described are merely some embodiments, not all of the embodiments of the present disclosure.

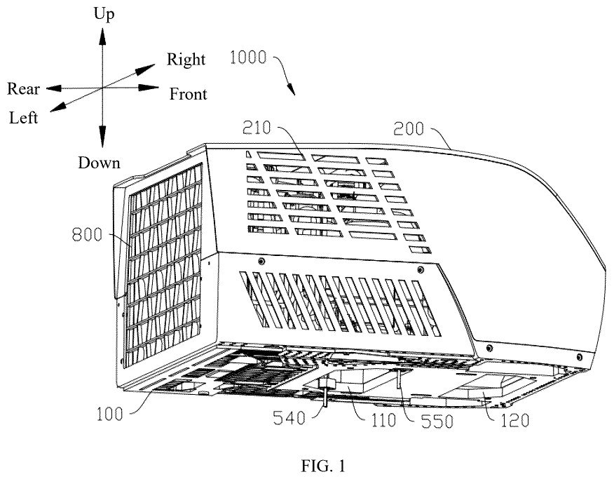

Referring to FIG. 1, a roof-mounted air conditioner 1000 according to an embodiment of the present disclosure includes a chassis 100 and a top cover 200 connected to the chassis 100. An indoor air inlet 110 and an indoor air outlet 120 are provided at a bottom of the chassis 100. An air intake grill 210 is provided on each of two sides of the chassis 100 and the top cover 200 to form an outdoor air inlet. An air exhaust grill 800 is provided on a rear side of the top cover 200 and the chassis 100 to form an outdoor air outlet. It may be understood that, using a recreational vehicle as an example, the roof-mounted air conditioner 1000 is mounted on the roof of the recreational vehicle. The roof of the recreational vehicle is provided with a mounting opening, and both the indoor air inlet 110 and the indoor air outlet 120 face downward and are in communication with the mounting opening, to realize indoor air circulation. Outside the roof-mounted air conditioner 1000, air flows in from left and right sides and flows out from the rear side, thus forming an outdoor airflow.

It should be noted that the orientations in the embodiments of the present disclosure, such as front, rear, left, right, up, and down directions, are all based on the chassis 100, and are described with reference to the orientation relationships indicated in FIG. 1. The front, rear, left, right up, and down directions of the roof-mounted air conditioner 1000 correspond one-to-one to those of the recreational vehicle.

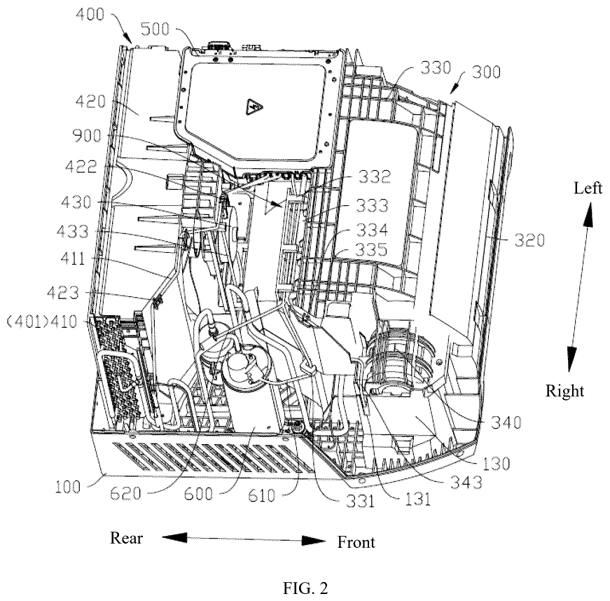

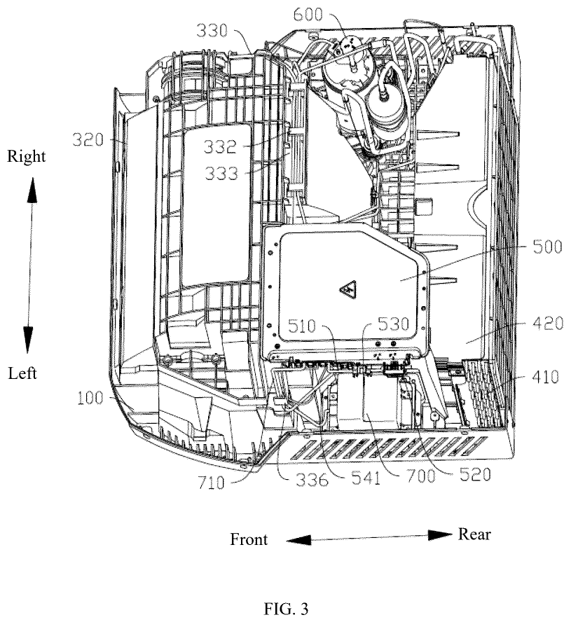

Referring to FIG. 2 and FIG. 3, FIG. 2 and FIG. 3 are structural assembled views of the roof-mounted air conditioner 1000 without the top cover 200. It may be understood that the roof-mounted air conditioner 1000 further includes an inner air duct assembly 300 and an outer air duct assembly 400. The inner air duct assembly 300 is mounted at a front portion of the chassis 100. The outer air duct assembly 400 is mounted at a rear portion of the chassis 100. The inner air duct assembly 300 and the outer air duct assembly 400 are spaced apart by a space, which is an air inlet channel of the outer air duct assembly 400. An electronic control box assembly 500 is mounted at a top of the air inlet channel. The electronic control box assembly 500 is erected between the inner air duct assembly 300 and the outer air duct assembly 400. The electronic control box assembly 500 is electrically connected to mounted components through wires. The mounted components include a compressor 600, an inner fan 340, an outer fan 430. The electronic control box assembly 500 is mounted on a side close to the chassis 100. The compressor 600 is mounted between the inner air duct assembly 300 and the outer air duct assembly 400, and is located on a side of the chassis 100 away from the electronic control box assembly 500. The compressor 600 is fixedly connected to the chassis 100.

Referring to FIG. 2 and FIG. 3, it may be understood that the inner air duct assembly 300 includes an indoor heat exchanger 301 and an inner air duct component 320. An inner air duct fixation cover 330 is provided on an outer side of the inner air duct component 320. The inner air duct component 320 is fixed to the chassis 100 through the inner air duct fixation cover 330. The inner air duct component 320 may include an upper component 321 and a lower component 322. An indoor air duct is formed by the upper component 321 and the lower component 322. The indoor air duct is in communication with the indoor air inlet 110 and the indoor air outlet 120. The indoor heat exchanger 301 is arranged in the indoor air duct and is located between the indoor air inlet 110 and the indoor air outlet 120. The indoor heat exchanger 301 is fixedly connected to the chassis 100. The inner air duct assembly 300 is further provided with an inner fan 340. The inner fan 340 includes an inner motor 341 and a cross-flow impeller 342. The cross-flow impeller 342 is arranged in the indoor air duct. The inner motor 341 is configured to drive the cross-flow impeller 342 to rotate to enable indoor air to flow along the indoor air duct, such that the indoor air passes through the indoor heat exchanger 301 for heat exchange.

Continuing with reference to FIG. 2 and FIG. 3, it may be understood that the outer air duct assembly 400 includes an outdoor heat exchanger 401 and an outer air duct fixation member 420. The outdoor heat exchanger 401 is fixed on the chassis 100 at a position close to the rear side of the chassis 100. The outer air duct fixation member 420 is fixedly connected to the chassis 100. The outer air duct fixation member 420 is arranged on a front side of the outdoor heat exchanger 401. The outer air duct fixation member is configured to support the outdoor heat exchanger 401. The outer air duct fixation member 420 may also be referred to as an outer air duct bracket. An air supply channel is formed between the outer air duct fixation member 420 and the outdoor heat exchanger 401. The air supply channel is in communication with the air inlet channel to form an outdoor air duct. The outer fan 430 is mounted on the outer air duct fixation member 420. Outdoor air may flow through the outdoor air inlet, the outdoor air duct, the outdoor heat exchanger 401, and the outdoor air outlet in sequence, such that the outdoor air passes through the outdoor heat exchanger 401 for heat exchange.

It may be understood that there is a pipeline structure around the compressor 600. The compressor 600 is connected to the indoor heat exchanger 301 and the outdoor heat exchanger 401 through the pipeline structure to form a circulation loop, thereby forming an entire refrigeration system. In the refrigeration system, the indoor heat exchanger 301 serves as an evaporator 310 and the outdoor heat exchanger 401 serves as a condenser 410. The following embodiments are described using the evaporator 310 and the condenser 410.

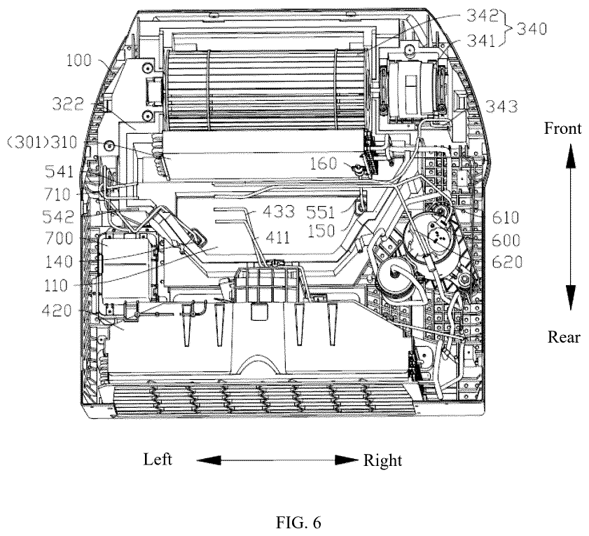

FIG. 6 is a structural view without the upper component 321, the inner air duct fixation cover 330, and the electronic control box assembly 500. Referring to FIG. 6, the evaporator 310 and the inner fan 340 are mounted at the front portion of the chassis 100, and the condenser 410 and the outer air duct fixation member are mounted at the rear portion of the chassis 100. In an embodiment, the indoor air duct is formed in the inner air duct component 320, such that the indoor air duct is separated from the outdoor air duct, to prevent communication between outdoor air and indoor air. The inner air duct component 320 may be made of a thermal insulation material. For example, the upper component 321 and the lower component 322 are made of a foam material, which has a thermal insulation effect. It should be noted that the front portion of the chassis 100 faces the front side of the recreational vehicle, and the rear portion of the chassis 100 faces the rear side of the recreational vehicle.

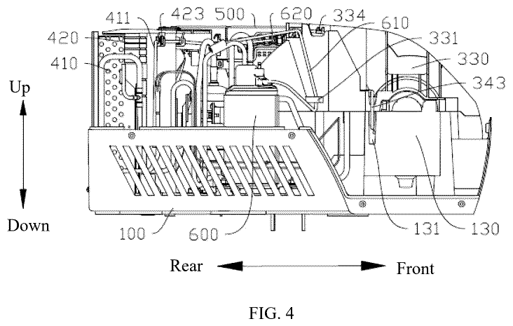

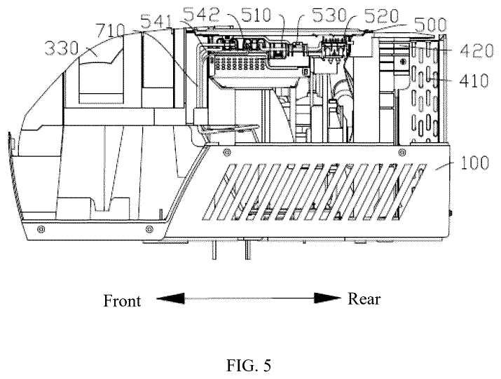

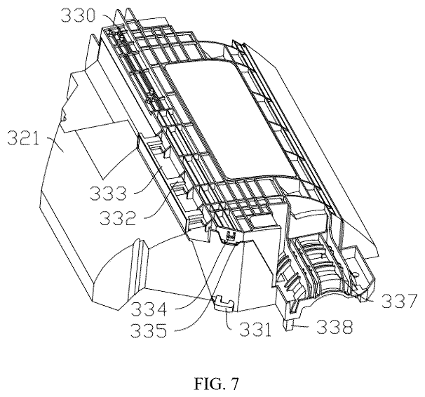

Referring to FIG. 4 and FIG. 5, it should be particularly noted that the electronic control box assembly 500 is mounted at a top of the inner air duct assembly 300 and the outer air duct assembly 400, such that the electronic control box assembly 500 is located at the top of the air inlet channel. In combination with FIG. 6 and FIG. 7, the inner air duct fixation cover 330 is a fixation cover arranged on a top of the upper component 321, two sides of the inner air duct fixation cover 330 are each provided with a mounting hole, and the chassis 100 is provided with fixation holes corresponding to the mounting holes. The inner air duct fixation cover 330 is fixedly connected to the chassis 100 by screws respectively passing through the mounting holes and the fixation holes. After assembly and fastening, the inner air duct fixation cover 330 presses the upper component 321 and the lower component 322 downward, such that the entire inner air duct component 320 is fixed, and a top of the inner air duct component 320 may support the electronic control box assembly 500. In addition, in an embodiment, the inner air duct fixation cover 330 may be provided with a positioning column, and the inner air duct component 320 may be provided with a positioning hole. As such, the inner air duct fixation cover 330 is positioned through engagement of the positioning column with the positioning hole, thereby effectively improving structural stability.

Considering that the roof-mounted air conditioner 1000 is mounted on the roof of a vehicle, and its internal electrical reliability faces a more complicated operating environment as the vehicle bumps, it is necessary to devise a reasonable design to ensure the electrical safety performance. Most of fixing schemes in the related art aim at fixing the wires near the outlet of the electronic control box assembly 500, and fail to provide a systematic wire fixing scheme for the entire air conditioner. As a result, the safety of the air conditioner cannot be fully guaranteed. In addition, such wire fixing methods rely on the use of an external auxiliary member, leading to additional costs and low operation efficiency.

In view of the above, in an embodiment of the present disclosure, a wire fixation mechanism 900 is arranged on the inner air duct fixation cover 330 or the outer air duct fixation member 420. The wire fixation mechanism 900 is configured to fix a wire that connects mounted components to the electronic control box assembly 500. The wire fixation mechanism 900 may be integrally formed with the inner air duct fixation cover 330 or the outer air duct fixation member 420. For example, the wire fixation mechanism 900 may be a wire buckle, a wire groove, or other structure, and does not require the use of an additional auxiliary member. In an embodiment, the wire fixation mechanism 900 may be arranged on each of the inner air duct fixation cover 330 and the outer air duct fixation member 420, to make the wiring structure more stable and reliable and the wire fixing mode more reasonable, and facilitate the organized arrangement of the wire connected to the mounted components, thereby reducing the costs and improving the assembly efficiency.

Referring to FIG. 2 and FIG. 3, the inner air duct fixation cover 330 and the outer air duct fixation member 420 are each provided with a plurality of wire fixation hooks. The plurality of wire fixation hooks are distributed at different positions on the inner air duct fixation cover 330 and the outer air duct fixation member 420, such that the wiring of the mounted components may be reasonably fixed. Specifically, the compressor 600 is mounted on the right side of the chassis 100, and a first wire fixation hook 331 is arranged on a side of the inner air duct fixation cover 330 close to the compressor 600. The first wire fixation hook 331 is configured to fix a first wire between the electronic control box assembly 500 and the compressor 600. The first wire is also referred to as a compressor wire 610. The compressor wire 610 extending out of a wire outlet at the top of is fixed at the first wire fixation hook 331, such that the compressor wire 610 is fixed near the wire outlet. The first wire fixation hook 331 is of a curved hook structure. The size of the hook structure is adjusted according to the dimension of the wire, and the shape of the hook structure is not limited herein. The wire may be easily fitted and fastened at the first wire fixation hook 331 after assembled without using any additional auxiliary member for fixing.

Referring to FIG. 4, in a height direction of the roof-mounted air conditioner 1000, a height of the first wire fixation hook 331 is less than a height of the wire outlet of the compressor 600. As such, the compressor wire 610 extends downward and is firstly fixed at the first wire fixation hook 331, and then extends upward. After being assembled in place, the compressor wire 610 forms a downward return bend near the wire outlet, to effectively prevent water flow from returning along the wire to the wire outlet of the compressor 600, thereby avoiding water erosion and damage.

Referring to FIG. 2, it may be understood that three second wire fixation hooks 332 are arranged at a top of the inner air duct fixation cover 330. The three second wire fixation hooks 332 are arranged at intervals in a direction from the compressor 600 to the electronic control box assembly 500. The compressor wire 610 extends upward after passing through the first wire fixation hook 331, and continues to extend along the top of the inner air duct fixation cover 330. The second wire fixation hooks 332 are used to fix the wire at the top of the inner air duct fixation cover 330 until the wire enters the electronic control box assembly 500, so that the wire that connects the compressor 600 to the electronic control box assembly 500 is effectively fixed.

It should be noted that the electronic control box assembly 500 is located on the top of the inner air duct fixation cover 330, and a plurality of wire inlets for wires to pass through are provided on an outer periphery of a box body of the electronic control box assembly 500. A wire inlet for the compressor wire 610 is arranged close to the second wire fixation hooks 332, such that the compressor wire 610 may directly enter the electronic control box assembly 500 after passing through the second wire fixation hooks 332. Such design may reduce the wire length required, to achieve the organized arrangement and reasonable fixing of the wire and avoid disorderly arrangement. It should be noted that the wire inlet of the electronic control box assembly 500 may be provided at a position higher than those of the second wire fixation hooks 332, such that water may not easily flow into the electronic control box assembly 500 along the wire, thereby reducing the risk of water entering the electronic control box assembly 500.

In addition, the second wire fixation hooks 332 may have the same curved hook structure as the first wire fixation hook 331. The number of the second wire fixation hooks 332 is not limited to the number described in the above embodiments, and may be set according to actual usage requirements to avoid disorder arrangement of the wire on the top of the inner air duct fixation cover 330. For example, two or more second wire fixation hooks 332 may be provided, which is not limited herein.

It should be noted that in an embodiment, a first wire passing groove 333 is provided on the top of the inner air duct fixation cover 330. The first wire passing groove 333 extends in the direction from the compressor 600 to the electronic control box assembly 500, an opening of the first wire passing groove 333 is arranged facing upward, and the second wire fixation hooks 332 are distributed along the opening of the first wire passing groove 333. Specifically, an end of the second wire fixation hook 332 is connected to a side wall of the first wire passing groove 333, and the second wire fixation hook 332 extends across the first wire passing groove 333 and another end is connected to the other side wall of first wire passing groove, such that the wire of the compressor 600 may run along the first wire passing groove 333 and be pressed by the second wire fixation hooks 332, thereby achieving a more organized arrangement of the wire and the wire is effectively protected.

Referring to FIG. 2, in some embodiments, the compressor 600 is provided with an exhaust pipe temperature sensing wire 620. The temperature of an exhaust pipe of the compressor 600 is detected using the exhaust pipe temperature sensing wire 620. The operation status of the compressor 600 may be learned according to the temperature of the exhaust pipe. The exhaust pipe temperature sensing wire 620 is fixed to a top of the exhaust pipe of the compressor 600, and is tensioned and fixed by the second wire fixation hooks 332 when passing through the first wire passing groove 333, such that the exhaust pipe temperature sensing wire 620 enters the wire inlet on a side of the electronic control box assembly 500 along the first wire passing groove 333 in a substantially straight line.

Referring to FIG. 2 and FIG. 6, it may be understood that the inner air duct assembly 300 includes an inner fan 340, and the inner fan 340 includes an inner motor 341 and a cross-flow impeller 342. The inner motor 341 is located on the right side of the inner air duct component 320 and is fixedly connected to the chassis 100. A housing 337 is arranged on the right side of the inner air duct fixation cover 330. After the inner air duct fixation cover 330 is assembled in place, the housing 337 covers the inner motor 341. A third wire fixation hook 334 is arranged on a right side wall of the inner air duct fixation cover 330. The third wire fixation hook 334 is located between a wire outlet position on the inner motor 341 and the second wire fixation hook 332. The number of the third wire fixation hooks 334 may be one or more, which is not limited herein. The third wire fixation hook 334 cooperates with the second wire fixation hooks 332 to fix a second wire between the inner fan 340 and the electronic control box assembly 500. The second wire is also referred to as an inner motor wire 343. The inner motor wire 343 extends out from a position close to the chassis 100, then extends upward through and be fixed by the third wire fixation hook 334, then continues to extend upward to pass the first wire passing groove 333, and finally enters the electronic control box assembly 500 along the first wire passing groove 333. A wire inlet corresponding to the inner motor wire 343 is provided on the side of the electronic control box assembly 500 close to an edge of the inner air duct fixation cover 330, such that the wire connected to the inner motor 341 may enter the electronic control box assembly 500 in a substantially straight line.

Referring to FIG. 2, in some embodiments, a second wire passing groove 335 perpendicular to the first wire passing groove 333 is further provided on the right side wall of the inner air duct fixation cover 330. The second wire passing groove 335 extends obliquely from a wire outlet position close to the inner motor 341 toward the first wire passing groove 333. The third wire fixation hook 334 is arranged in the second wire passing groove 335. As such, the inner motor wire 343 may pass through the second wire passing groove 335 and the first wire passing groove 333 in sequence. The inner motor wire 343 is tightly pressed by the third wire fixation hook 334 when passing through the second wire passing groove 335, and is tightly pressed by the second wire fixation hooks 332 when passing through the first wire passing groove 333. In this way, the inner motor wire 343 is effectively fixed.

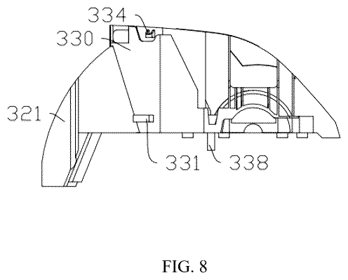

Referring to FIG. 6, it should be noted that the chassis 100 is provided with a support base 130, the inner motor 341 is fixedly mounted in the support base 130, a wire outlet slot 131 is provided on a side wall of the support base 130, and the inner motor wire 343 extends out from the wire outlet slot 131. Referring to FIG. 7 and FIG. 8, the inner air duct fixation cover 330 is provided with a wire pressing column 338. The wire pressing column 338 is located at a bottom of the housing 337 and extends downward, and the wire pressing column 338 is integrally formed with the inner air duct fixation cover 330.

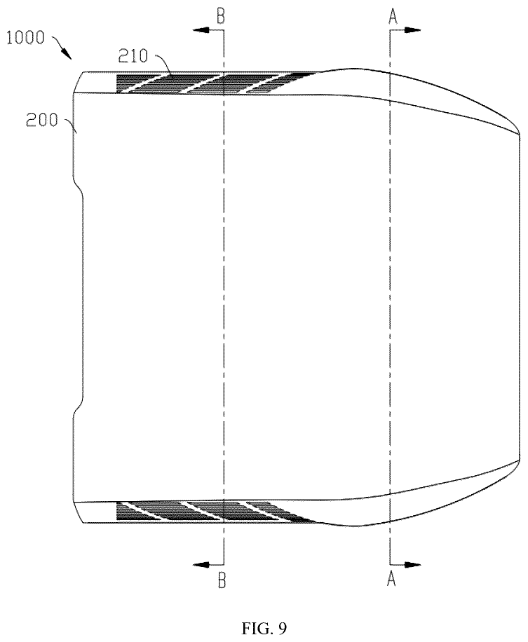

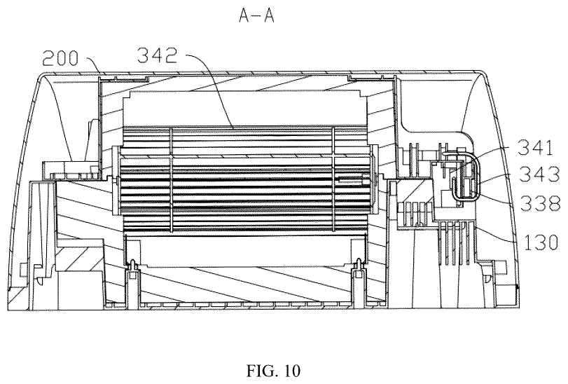

Referring to FIG. 9 and FIG. 10, after the inner air duct fixation cover 330 is assembled in place, the housing 337 covers the support base 130, and the wire pressing column 338 presses the wire downward, such that the wire is bent downward to form a return bend, and then extends out along the wire outlet slot 131. The return bend may effectively prevent water flow from returning along the wire to enter the inner motor 341, thereby reducing the risk of water entering the inner motor 341.

It should be noted that the inner motor wire 343, the compressor wire 610, and the exhaust pipe temperature sensing wire 620 are routed along the first wire passing groove 333 together and are fixed by the second wire fixation hooks 332, thereby simplifying the wire fixation mechanism 900, making the wiring more reasonable, and reducing the wire length required. It may be understood that the inner air duct fixation cover 330 is fixedly connected to the chassis 100, and after being fastened, the inner air duct fixation cover 330 presses the entire inner air duct component 320 downward, and the top supports the electronic control box assembly 500. The use of the first wire passing groove 333, the second wire passing groove 335, the first wire fixation hook 331, the second wire fixation hooks 332 and the third wire fixation hook 334 in combination to fix the wires may effectively prevent the relative pulling of the wires.

Referring to FIG. 3, it may be understood that the roof-mounted air conditioner 1000 needs to be powered by a vehicle, a power cable 541 needs to be connected to the electronic control box assembly 500 from an interior of the recreational vehicle. Since the indoor air inlet 110 is in communication with the interior of the recreational vehicle, the power cable 541 may extend out from the electronic control box assembly 500, pass through the indoor air inlet 110, and then enter the interior of the recreational vehicle. Specifically, a wire inlet for the power cable 541 is provided on a side of the electronic control box assembly 500 away from the compressor 600, a fourth wire fixation hook 336 is provided on the left side of the inner air duct fixation cover 330, and the fourth wire fixation hook 336 is close to the wire inlet for the power cable 541 and is located below the electronic control box assembly 500.

Referring to FIG. 5 and FIG. 6, a fifth wire fixation hook 140 is provided on a side wall of the indoor air inlet 110. The fourth wire fixation hook 336 and the fifth wire fixation hook 140 may cooperate to fix a third wire 540. The third wire 540 includes at least the power cable 541. As such, the power cable 541 is effectively fixed. It should be noted that, considering that a display panel needs to be provided in the vehicle to display information such as the operation status of the roof-mounted air conditioner 1000 in real time, a wire of the display panel needs to be introduced into the roof-mounted air conditioner 1000 through the indoor air inlet 110 and be connected to the electronic control box assembly 500. The wire of the display panel is also referred to as a signal cable 542. Therefore, in an embodiment, the third wire 540 includes the power cable 541 and the signal cable 542, and the third wire 540 is fixed at the fourth wire fixation hook 336 and the fifth wire fixation hook 140.

Referring to FIG. 5 and FIG. 6, the power cable 541 and the signal cable 542 extend upward from the indoor air inlet 110 into the roof-mounted air conditioner 1000, and is firstly fixed by the fifth wire fixation hook 140 on the side wall of the indoor air inlet 110. Then, the power cable 541 and the signal cable 542 continue to extend upward and are bent to pass through a wire passing port on the lower component 322, and extend to the left side of the inner air duct fixation cover 330. Next, the power cable 541 and the signal cable 542 are bent toward the front portion of the roof-mounted air conditioner 1000 to extend upward, then fixed to the side of the inner air duct fixation cover 330 by the fifth wire fixation hook 140, and finally extend upward and are bent toward the rear portion of the roof-mounted air conditioner 1000, and extends into the electronic control box assembly 500. It should be noted that the wire inlet that the power cable 541 enters is located on the side of the electronic control box assembly 500 away from the compressor 600 and close to an edge of the inner air duct fixation cover 330, and the wire inlet that the signal cable 542 enters is located on the side of the electronic control box assembly 500 away from the compressor 600 and centrally biased towards the inner air duct fixation cover 330, such that both the power cable 541 and the signal cable 542 are effectively fixed.

Still referring to FIG. 6, a sixth wire fixation hook 150 is further provided on the side wall of the indoor air inlet 110. The sixth wire fixation hook 150 is configured to fix an indoor environment temperature sensing wire 551. The indoor environment temperature sensing wire 551 extends upward from the indoor air inlet 110 into the roof-mounted air conditioner 1000. The indoor environment temperature sensing wire 551 may be fixed by the sixth wire fixation hook 150. It should be noted that in some embodiments, a first wire fixation member 160 may be arranged on a surface of the evaporator 310 close to the indoor air inlet 110, the indoor environment temperature sensing wire 551 is fixed at the sixth wire fixation hook 150 and then extends downward to a position close to the evaporator 310, and an end of the indoor environment temperature sensing wire 551 may be fixed by the first wire fixation member 160. As such, the indoor environment temperature sensing wire 551 is effectively fixed.

It should be noted that in some embodiments, the evaporator 310 may be provided with an evaporator pipeline temperature sensing wire. The evaporator pipeline temperature sensing wire extends downward from the evaporator 310 and enters the vehicle through the indoor air inlet 110. A fourth wire 550 includes the evaporator pipeline temperature sensing wire and the indoor environment temperature sensing wire 551, and the fourth wire 550 is fixed to the indoor air inlet 110 by the sixth wire fixation hook 150. It should be noted that the fifth wire fixation hook 140 and the sixth wire fixation hook 150 are arranged spaced apart to avoid electromagnetic interference between wires. In combination with reference to FIG. 1, the third wire 540 and the fourth wire 550 both extend out from the indoor air inlet 110 to avoid the formation of condensed water on the wires. In an embodiment, the fifth wire fixation hook 140 is provided on the side wall of the indoor air inlet 110 away from the compressor 600, and the sixth wire fixation hook 150 is provided on the side wall of the indoor air inlet 110 close to the compressor 600.

It should be noted that the roof-mounted air conditioner 1000 in an embodiment of the present disclosure is an inverter air conditioner. The power cable 541, the signal cable 542, the indoor environment temperature sensing wire 551, and the evaporator pipeline temperature sensing wire all extend downward out of the roof-mounted air conditioner 1000 from the indoor air inlet 110 and then enter the interior of the recreational vehicle. The power cable 541 is directly connected to a power supply line of the recreational vehicle. The signal cable 542, the indoor environment temperature sensing wire 551, and the evaporator pipeline temperature sensing wire may be connected to a control display panel in the recreational vehicle. The mounting of the entire roof-mounted air conditioner 1000 on the recreational vehicle and the fixing of the wires may be implemented using the wire fixation mechanism 900 of the embodiments.

In addition, it should be noted that in the embodiments, the wires pass through the indoor air inlet 110 to realize the installation of power supply and control lines for the operation of the roof-mounted air conditioner 1000, and there is no need to design a wire passing port on the chassis 100 of the roof-mounted air conditioner 1000, thereby avoiding the problem of water entering the recreational vehicle through the wire passing port. Moreover, the wires enter the recreational vehicle through the indoor air inlet 110, not the indoor air outlet 120, which may avoid the problem that the wires passing through the indoor air outlet 120 are cooled by low-temperature cold air generated by the refrigeration system, and further avoid the problem of formation of condensed water on the surface of the wires due to various factors, such as the cooling of the wires, or heat exchange of the wires with ambient cold air caused by the temperature rise of the wires due to internal heat generation or intermittent shutdown, which otherwise leads to the problem of water entering wire terminals to cause electrical safety hazards such as short circuit and electrical leakage. As such, the electrical safety performance of the roof-mounted air conditioner 1000 is greatly improved.

Referring to FIG. 2, in some embodiments, the mounted components further includes a reactor 700. The reactor 700 is fixed to the chassis 100 and is located below the electronic control box assembly 500. Referring to FIG. 6, a wire of the reactor 700 is referred to as a reactor wire 710. The reactor wire 710 extends out from the side close to the inner air duct fixation cover 330, and is then bent to extend upward and be fixed at the fourth wire fixation hook 336, and finally extends upward and is bent toward the rear portion of the roof-mounted air conditioner 1000, and extends into the electronic control box assembly 500.

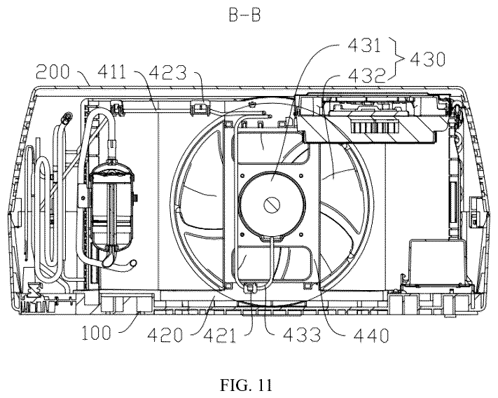

Referring to FIG. 2, the outer fan 430 is mounted on the outer air duct fixation member 420, and the outer air duct fixation member 420 is provided with a seventh wire fixation hook 421 configured to fix a fifth wire between the electronic control box assembly 500 and the outer fan 430. Referring to FIG. 9 and FIG. 11, the outer fan 430 includes an outer motor 431 and an impeller 432 connected to the outer motor 431. The outer motor 431 is fixed to the outer air duct fixation member 420 through a mounting frame 440. The seventh wire fixation hook 421 is formed at a bottom of the outer air duct fixation member 420. The seventh wire fixation hook 421 is located at a height lower than a wire outlet of the outer fan 430. An eighth wire fixation hook 422 is arranged at a top of the outer air duct fixation member 420. The outer motor 431 is mounted in a middle of the mounting frame 440. A wire of the outer motor 431 extends downward at a rear portion. The fifth wire is also referred to as an outer motor wire 433. The outer motor wire 433 first extends straight downward, is then bent upward and clamped by the seventh wire fixation hook 421 at the bending point, is tensioned to extend straight upward across the top of the outer air duct fixation member 420, is clamped and fixed by the eighth wire fixation hook 422, and is then bent to extend into the electronic control box assembly 500 along the left-right direction of the roof-mounted air conditioner 1000. It should be noted that the outer motor wire 433 enters the electronic control box assembly 500 through a wire inlet that is located on the side of the electronic control box assembly 500, which is positioned midway and biased towards the outer air duct fixation member 420.

Referring to FIG. 2, in an embodiment, the condenser 410 is provided with an outlet pipe temperature sensing wire 411, and a ninth wire fixation hook 423 is arranged on the top of the outer air duct fixation member 420. In an embodiment, two ninth wire fixation hooks 423 are provided, and the two ninth wire fixation hooks 423 are spaced apart along the top of the outer air duct fixation member 420. It may be understood that the eighth wire fixation hook 422 is located at a middle position on the top of the outer air duct fixation member 420 and is close to the electronic control box assembly 500. The two ninth wire fixation hooks 423 are distributed close to the right side of the outer air duct fixation member 420. An end of the outlet pipe temperature sensing wire 411 is inserted in and thus fixed to a pipeline of the condenser 410. Then, the wire extends along the top of the outer air duct fixation member 420 and are clamped and fixed by the ninth wire fixation hooks 423 and the eighth wire fixation hook 422 in sequence, and finally enters a wire inlet that is on an edge of a side of the electronic control box assembly 500 close to the outer air duct fixation member 420. It should be noted that the outlet pipe temperature sensing wire 411 and the outer motor wire 433 are fixed at the eighth wire fixation hook 422 together, and therefore may enter the electronic control box assembly 500 in a substantially straight line, making the wiring more reasonable. In addition, the eighth wire fixation hook 422 and the ninth wire fixation hooks 423 may be in the form of a buckle, which may facilitate the clamping of the wires.

Referring to FIG. 3 and FIG. 5, the electronic control box assembly 500 is provided with an outdoor environment temperature sensing wire 510. The outdoor environment temperature sensing wire 510 extends out from a wire inlet which is on the side of the electronic control box assembly 500 away from the compressor 600. The wire inlet is located at an edge of the electronic control box assembly 500 close to the outer air duct fixation member 420. Then, the outdoor environment temperature sensing wire 510 extends along the edge of the electronic control box assembly 500 toward the rear portion of the roof-mounted air conditioner 1000. The outdoor environment temperature sensing wire 510 is fixed by a second wire fixation member 520 on a side wall of the electronic control box assembly 500. In this way, the outdoor environment temperature sensing wire 510 is fixed to the edge of the side of the electronic control box assembly 500 close to the outer air duct fixation member 420. It may be understood that the outdoor environment temperature sensing wire 510 faces the air intake grill 210 on the top cover 200 to sense the ambient temperature of outdoor air.

It should be noted that a tenth wire fixation hook 530 may be further arranged at the side of the electronic control box assembly 500 to fix the outdoor environment temperature sensing wire 510, which is determined according to actual usage requirements. In some embodiments, the second wire fixation member 520 may be arranged at a position on the outer air duct fixation member 420 close to the air intake grill 210. With such a design, the outdoor environment temperature sensing wire 510 may also sense the ambient temperature of outdoor air.

It may be understood that in the embodiments of the present disclosure, the wire fixation hooks are arranged at positions such as those on the inner air duct fixation cover 330, the outer air duct fixation member 420, and the indoor air outlet 120, such that the wires of the mounted components in the above embodiments are effectively fixed. Such a wire fixing method is effective and more reliable, and solves the problem of shaking and friction of the wires in the roof-mounted air conditioner 1000 during bumping of the vehicle due to insufficient fixation, thereby preventing wear of the wires. In addition, the design of the wiring structure is more reasonable, thereby avoiding electromagnetic interference between wires and improving the overall electrical safety performance of the roof-mounted air conditioner 1000. It should be noted that the electronic control box assembly 500 is provided with wire inlets matching various wires, to facilitate the organized arrangement of corresponding wires during production and avoid errors. The reasonable design of the wire inlets may effectively improve the wiring efficiency during production. The wire inlets are arranged to be higher than the structures of all the corresponding wire fixation hooks and wire passing grooves, such that the wires in the roof-mounted air conditioner 1000 are at relatively high positions in the top, thereby solving the problem of water entering the electronic control box assembly 500 along the wires.

An embodiment of the present disclosure provides a vehicle, including the roof-mounted air conditioner 1000 of the above embodiments. The vehicle is, for example, a recreational vehicle. Using a recreational vehicle as an example, the roof-mounted air conditioner 1000 is mounted on the roof of the recreational vehicle, and both the indoor air inlet 110 and the indoor air outlet 120 are in communication with a mounting opening on the roof, to realize indoor air circulation. Outside the roof-mounted air conditioner 1000, air flows in from two sides and flows out from the rear side, thus forming an outdoor airflow. Because the vehicle adopts all the technical schemes of the roof-mounted air conditioner 1000 of the above embodiments, the motor has at least all the beneficial effects achieved by the technical schemes of the above embodiments, and the details will not be repeated here.

The embodiments of the present disclosure have been described in detail above with reference to the accompanying drawings, but the present disclosure is not limited to the above embodiments, and various changes may be made within the knowledge of those having ordinary skills in the art without departing from the protection scope of the present disclosure.

1.-16. (canceled)

17. A roof-mounted air conditioner comprising:
a chassis, provided with an indoor air inlet and an indoor air outlet;
a compressor, arranged on the chassis;
an inner air duct assembly, including:
an inner fan arranged between the indoor air inlet and the indoor air outlet;
an inner air duct component forming an indoor air duct communicating the indoor air inlet and the indoor air outlet; and
an inner air duct fixation cover fixedly connected to the chassis to secure the inner air duct component;
an outer air duct assembly, including:
an outer air duct fixation member fixedly connected to the chassis; and
an outer fan fixedly connected to the outer air duct fixation member;
an electronic control box assembly, arranged between the inner air duct fixation cover and the outer air duct fixation member; and
a wire fixation mechanism, provided on at least one of the inner air duct fixation cover or the outer air duct fixation member and configured to fix a wire having one end connected to the electronic control box assembly.

18. The roof-mounted air conditioner of claim 17, wherein the compressor is fixedly connected to a side of the chassis away from the electronic control box assembly, the wire fixation mechanism includes a wire fixation hook arranged on the inner air duct fixation cover, and the wire fixation hook is configured to fix the wire between the electronic control box assembly and the compressor.

19. The roof-mounted air conditioner of claim 18, wherein the wire fixation hook is arranged on a side of the inner air duct fixation cover close to the compressor, and a height of the wire fixation hook is less than a height of a wire outlet of the compressor.

20. The roof-mounted air conditioner of claim 19, wherein:
the wire fixation hook is a first wire fixation hook; and
the wire fixation mechanism further includes at least one second wire fixation hook arranged at a top of the inner air duct fixation cover, and the at least one second wire fixation hook is at least configured to fix the wire together with the first wire fixation hook.

21. The roof-mounted air conditioner of claim 20, wherein:
the wire is a first wire; and
the wire fixation mechanism further includes a third wire fixation hook arranged between a wire outlet position on the inner fan and the at least one second wire fixation hook and is configured to fix a second wire between the inner fan and the electronic control box assembly together with the at least one second wire fixation hook.

22. The roof-mounted air conditioner of claim 21, wherein the wire fixation mechanism further includes a wire passing groove provided at the top of the inner air duct fixation cover, and the at least one second wire fixation hook is formed at an opening of the wire passing groove.

23. The roof-mounted air conditioner of claim 22, wherein:
the wire passing groove is a first wire passing groove; and
a second wire passing groove perpendicular to the first wire passing groove is on a side of the inner air duct fixation cover close to the inner fan, and the third wire fixation hook is arranged in the second wire passing groove.

24. The roof-mounted air conditioner of claim 21, wherein:
the inner fan includes an inner motor and an inner impeller connected to the inner motor, and the inner impeller is arranged in the inner air duct;
the chassis is provided with a support base;
the inner motor is fixed to the support base;
the support base is provided with a wire outlet slot; and
the inner air duct fixation cover is provided with a wire pressing column, and the wire pressing column is configured to press the second wire to bend downward and extend out of the wire outlet slot.

25. The roof-mounted air conditioner of claim 17, wherein a first wire fixation hook is arranged on a side of the inner air duct fixation cover close to the electronic control box assembly, a second wire fixation hook is arranged on a side wall of the indoor air inlet, and the second wire fixation hook and the fourth wire fixation hook are configured to fix at least a power cable connected to the electronic control box assembly.

26. The roof-mounted air conditioner of claim 17, wherein a wire fixation hook configured to fix at least an indoor environment temperature sensing wire is further provided on the side wall of the indoor air inlet.

27. The roof-mounted air conditioner of claim 17, wherein the wire fixation mechanism includes a wire fixation hook at a height lower than a wire outlet of the outer fan, and the wire fixation hook is configured to fix the wire between the electronic control box assembly and the outer fan.

28. The roof-mounted air conditioner of claim 27, wherein:
the wire fixation hook is a first wire fixation hook; and
the wire fixation mechanism further includes a second wire fixation hook arranged at a top of the outer air duct fixation member and is configured to fix the wire together with the first wire fixation hook.

29. The roof-mounted air conditioner of claim 28, wherein an outdoor heat exchanger in the outer air duct assembly is provided with an outlet pipe temperature sensing wire, the wire fixation mechanism further includes a third wire fixation hook arranged at the top of the outer air duct fixation member, and the third wire fixation hook is configured to fix the outlet pipe temperature sensing wire together with the second wire fixation hook.

30. The roof-mounted air conditioner of claim 17, further comprising:
a top cover connected to the chassis and provided with an air intake grille;
wherein the electronic control box assembly or the outer air duct fixation member is provided with a wire fixation member close to the air intake grille, and the wire fixation member is configured to fix an outdoor environment temperature sensing wire.

31. The roof-mounted air conditioner of claim 17, wherein the electronic control box assembly is connected to a top of the inner air duct fixation cover and the outer air duct fixation member, the electronic control box assembly is provided with a plurality of wire inlets for the wire to pass through, and the plurality of wire inlets are each at a height higher than the wire fixation mechanism.

32. A vehicle comprising a roof-mounted air conditioner including:
a chassis, provided with an indoor air inlet and an indoor air outlet;
a compressor, arranged on the chassis;
an inner air duct assembly, including:
an inner fan arranged between the indoor air inlet and the indoor air outlet;
an inner air duct component forming an indoor air duct communicating the indoor air inlet and the indoor air outlet; and
an inner air duct fixation cover fixedly connected to the chassis to secure the inner air duct component;
an outer air duct assembly, including:
an outer air duct fixation member fixedly connected to the chassis; and
an outer fan fixedly connected to the outer air duct fixation member;
an electronic control box assembly, arranged between the inner air duct fixation cover and the outer air duct fixation member; and
a wire fixation mechanism, provided on at least one of the inner air duct fixation cover or the outer air duct fixation member and configured to fix a wire having one end connected to the electronic control box assembly.
